(19) United States
(12) Patent Application Publication
(10) Pub. No.: US 2024/0241076 A1
(43) Pub. Date: Jul. 18, 2024

(54) SENSOR ELEMENT AND GAS SENSOR

(71) Applicant: NITERRA CO., LTD., Nagoya-shi (JP)

(72) Inventors: Yasumitsu Shimizu, Nagoya-shi (JP); Futa Aoshima, Nagoya-shi (JP); Hitoshi Furuta, Nagoya-shi (JP)

(73) Assignee: NITERRA CO., LTD., Nagoya-shi (JP)

(21) Appl. No.: 18/410,399

(22) Filed: Jan. 11, 2024

(30) Foreign Application Priority Data
Jan. 12, 2023 (JP) 2023-002952

(51) Int. Cl. G01N 27/407

(52) U.S. Cl. CPC G01N 27/4077; G01N 27/4075

(57) ABSTRACT

A sensor element 100 including: a detection electrode (106a) and a reference electrode 104a; and one pair of lead portions respectively connected to the detection electrode and the reference electrode, wherein out of the one pair of lead portions, a reference lead portion 104b that is connected to the reference electrode is configured to include noble metal particles 151 of one type or more selected from the group of Pt, Pd, Rh, and Au, ceramic particles 153 having an equivalent circle diameter larger than that of the noble metal particles, and a voids G1, G2, and when a cross section that crosses, in a longitudinal direction of, the reference lead portion is viewed, a relationship of a lead portion film thickness t<(a maximum particle size M of the ceramic particles×3)<a lead portion width W is satisfied.

### BACKGROUND OF THE INVENTION

### 1. Field of the Invention

The present invention relates to: a sensor element that is suitably used for detecting the concentration of a specific gas contained in combustion gas or exhaust gas from a combustor, an internal combustion engine, or the like, for example; and a gas sensor.

### 2. Description of the Related Art

A gas sensor for detecting the concentration of a specific component (e.g., oxygen) in exhaust gas from an internal combustion engine is known. A gas sensor of this type includes therein a sensor element having an elongated plate shape. A front end portion of the sensor element is provided with a detection portion for detecting the specific component (e.g., Patent Document 1).

The detection portion may be composed of a detection electrode and a reference electrode, and a solid electrolyte, and a lead portion extending toward the rear end side from each electrode. Here, there is a detection portion having a structure in which voids are formed inside a reference lead portion connected to the reference electrode, such that communication is allowed between gases inside and outside the sensor element via the reference lead portion, whereby the pressure of a reference gas around the reference electrode is adjusted.

[Patent Document 1] Japanese Patent Application Laid-Open (kokai) No. 2022-033240.

### 3. Problem(s) to be Solved by the Invention

The reference lead portion is formed by subjecting a conductive paste to screen printing or the like and then sintering the resultant matter. If there is a variation in the print thickness, when the film thickness of the reference lead portion becomes large, then there is a problem in that the detection value (electromotive force) of the gas sensor decreases to a large extent, resulting in varied characteristics and quality of the gas sensor (e.g., decreased detection accuracy). This is considered to be caused because, when the film thickness of the reference lead portion becomes large, voids inside the lead portion become large, and the measurement target gas is readily discharged through the voids.

### SUMMARY OF THE INVENTION

An object of the present invention is to provide a sensor element and a gas sensor in which variation in characteristics of the gas sensor due to voids in a reference lead portion connected to an electrode is suppressed.

The above object of the invention has been achieved by providing (1) a sensor element comprising: a detection electrode configured to come into contact with a measurement target gas, and a reference electrode configured to come into contact with a reference gas; and one pair of lead portions respectively connected to the detection electrode and the reference electrode, the sensor element being configured to measure a target component in the measurement target gas by the detection electrode and the reference electrode, wherein out of the one pair of lead portions, a reference lead portion that is connected to the reference electrode is configured to include noble metal particles of one type or more selected from the group of Pt, Pd, Rh, and Au; ceramic particles having an equivalent circle diameter larger than that of the noble metal particles; and a void, and when a cross section that crosses, in a longitudinal direction of, the reference lead portion is viewed, a relationship of a lead portion film thickness t<(a maximum particle size M of the ceramic particles×3)<a lead portion width W is satisfied.

When voids inside the reference lead portion become large, the measurement target gas is readily discharged through the voids and characteristics of the gas sensor tend to change.

The voids in the lead portion are considered to include: internal voids; and interface voids between the lead portion and other members that are respectively in contact with both surfaces of the lead portion. The area of the interface voids, out of those voids, does not vary to a large extent even when the film thickness t is changed. Therefore, when t<M×3 is satisfied, the film thickness t is small, and thus, the number of the internal voids is small, and the interface voids account for the majority of the voids. Therefore, even when the film thickness t is changed, the total area of the voids does not vary to a large extent. Therefore, it is possible to suppress characteristics of the gas sensor from varying.

In contrast to this, when t≥M×3 is satisfied, the film thickness t is large, and thus, the internal voids increase in number in accordance with increase in the film thickness t, and the total area of the voids increases in accordance with the film thickness t. Therefore, the characteristics of the gas sensor also vary in accordance with the film thickness t.

In a preferred embodiment (2) of the sensor element of the present invention, in the cross section, the void may include an internal void G1 in the reference lead portion and an interface void G2 between the reference lead portion and each of other members that are respectively in contact with both surfaces of the reference lead portion, and an area of G1 may account for not higher than 10% relative to a total area of G1 and G2.

With this sensor element, even when the film thickness t is changed, variation in the total area of the voids G1, G2 is further reduced, and characteristics of the gas sensor can be further suppressed from varying.

In another embodiment (3), a gas sensor of the present invention is a gas sensor comprising: the sensor element and a metal shell holding the sensor element.

### Advantageous Effect(s) of the Invention

According to this invention, it is possible to suppress variation in characteristics of the gas sensor due to voids in the reference lead portion connected to an electrode.

### BRIEF DESCRIPTION OF THE DRAWINGS

FIG. 1 is a cross-sectional view of a gas sensor cut along the direction of an axial line thereof.

FIG. 2 is an exploded perspective view schematically showing a detection element portion and a heater portion forming a sensor element.

FIG. 3 is a schematic diagram of a cross section that crosses, in the longitudinal direction of, the first lead portion when t<M×3.

FIG. 4 is a schematic diagram of a cross section that crosses, in the longitudinal direction of, the first lead portion when t≥M×3.

FIG. 5 is a diagram of a relationship between the lead portion film thickness t and the characteristic (electromotive force) of the gas sensor.

FIG. 6 is a diagram of a cross-sectional SEM images of the first lead portion when t<M×3.

FIG. 7 is a diagram of voids G1, G2 extracted through image analysis of FIG. 6.

FIG. 8 is a diagram of a cross-sectional SEM images of the first lead portion when t≥M×3.

FIG. 9 is a diagram of voids G1, G2 extracted through image analysis of FIG. 8.

### DESCRIPTION OF REFERENCE NUMERALS

Reference numerals used to identify various features in the drawings include the following:
1: gas sensor
30: metal shell
100: sensor element
104a: reference electrode
106a: detection electrode
104b: reference lead portion (one pair of lead portions)
106b: second lead portion (one pair of lead portions)
151: noble metal particle
153: ceramic particle
G1, G2: void

### DETAILED DESCRIPTION OF THE PREFERRED EMBODIMENTS

Hereinafter, embodiments of the present invention will be described with reference to the drawings. However, the present invention should not be construed as being limited thereto.

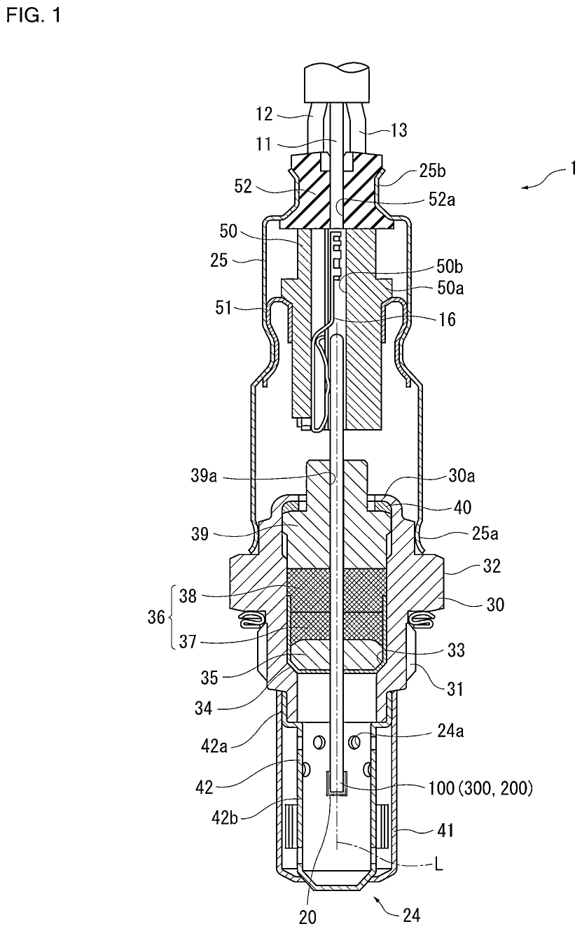

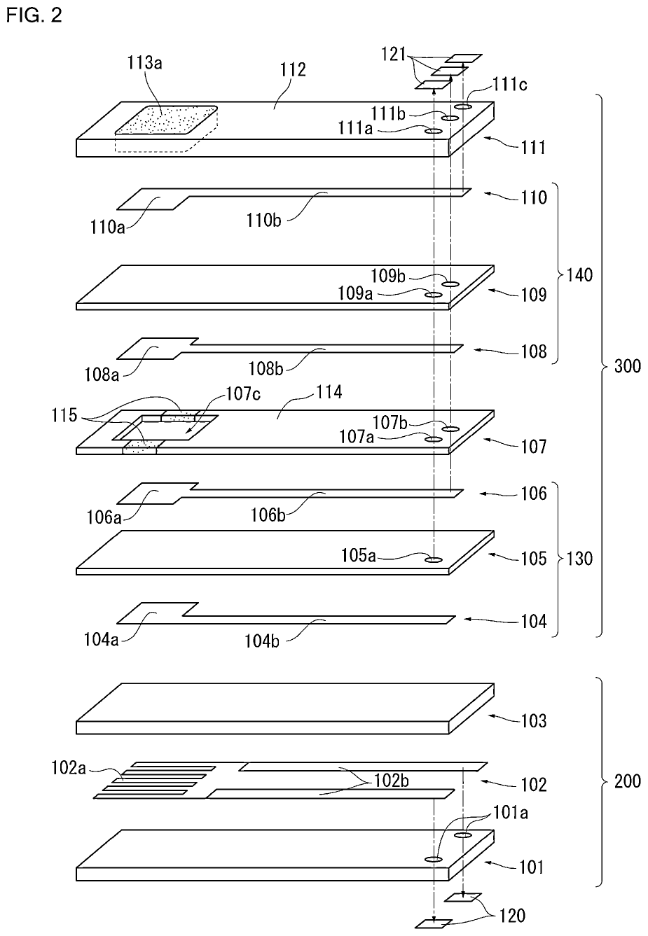

First, a configuration of a gas sensor (oxygen sensor) 1 including a sensor element 100 according to the present embodiment is described. FIG. 1 is a cross-sectional view of the gas sensor 1 cut along a direction of an axial line L. FIG. 2 is an exploded perspective view schematically showing a detection element portion 300 and a heater portion 200 forming the sensor element 100. In the present disclosure, the lower side of the gas sensor 1 shown in

FIG. 1 will be referred to as “front end side” and the opposite side (upper side in FIG. 1) thereto will be referred to as “rear end side”.

As shown in FIG. 1, the gas sensor 1 includes: the sensor element 100 implemented as a stacked body of the detection element portion 300 and the heater portion 200; a metal shell 30 which holds the sensor element 100 and the like so as to be accommodated therein; and a protector 24 that is mounted to a front end portion of the metal shell 30. The sensor element 100 has an elongated plate shape as a whole, and is disposed such that the longitudinal direction thereof extends along the direction of the axial line L. As described later, a porous protection layer 20 is formed on the front end side of the sensor element 100.

As shown in FIG. 2, the heater portion 200 has an elongated plate shape as a whole, and includes a first base body 101 and a second base body 103 which each contain alumina as a main material; and a heating element 102 which is sandwiched by the first base body 101 and the second base body 103 and which contains platinum as a main material. The heating element 102 includes: a heat generation portion 102a positioned on the front end side; and a pair of heater lead portions 102b extending from the heat generation portion 102a along the longitudinal direction (the direction of the axial line L) of the first base body 101. Ends of the heater lead portions 102b are electrically connected to heater-side pads 120, respectively, via conductors formed in heater-side through-holes 101a provided in the first base body 101.

Similar to the heater portion 200, the detection element portion 300 has an elongated plate shape as a whole, and includes an oxygen concentration detection cell 130 and an oxygen pump cell 140. The oxygen concentration detection cell 130 is composed of: a first solid electrolyte 105; and a first electrode 104 and a second electrode 106 formed at both faces of the first solid electrolyte 105. The first electrode 104 is composed of: a first electrode portion 104a; and a first lead portion 104a extending from the first electrode portion 104a along the longitudinal direction (the direction of the axial line L) of the first solid electrolyte 105. The second electrode 106 is composed of: a second electrode portion 106a; and a second lead portion 106b extending from the second electrode portion 106a along the longitudinal direction (the direction of the axial line L) of the first solid electrolyte 105.

An end of the first lead portion 104b is electrically connected to a detection- element-side pad 121 via a conductor formed in each of a first through-hole 105a provided in the first solid electrolyte 105, a second through-hole 107a provided in an insulation layer 107 described later, a fourth through-hole 109a provided in a second solid electrolyte 109, and a sixth through-hole 111a provided in a protection layer 111. An end of the second lead portion 106b is electrically connected to a detection-element-side pad 121 via a conductor formed in each of a third through-hole 107b provided in the insulation layer 107 described later, a fifth through-hole 109b provided in the second solid electrolyte 109, and a seventh through-hole 111b provided in the protection layer 111.

Here, the first electrode portion 104a and the second electrode portion 106a each corresponds to “reference electrode” and “detection electrode” in the claims. And the first lead portion 104a corresponds to “reference lead portion” in the claims.

The oxygen pump cell 140 is composed of: the second solid electrolyte 109; and a third electrode 108 and a fourth electrode 110 formed at both faces of the second solid electrolyte 109. The third electrode 108 is composed of: a third electrode portion 108a; and a third lead portion 108b extending from the third electrode portion 108a along the longitudinal direction (the direction of the axial line L) of the second solid electrolyte 109. The fourth electrode 110 is composed of: a fourth electrode portion 110a; and a fourth lead portion 110b extending from the fourth electrode portion 110a along the longitudinal direction (the direction of the axial line L) of the second solid electrolyte 109.

An end of the third lead portion 108b is electrically connected to a detection-element-side pad 121 via a conductor formed in each of the fifth through-hole 109b provided in the second solid electrolyte 109 and the seventh through-hole 111b provided in the protection layer 111. An end of the fourth lead portion 110b is electrically connected to a detection- element-side pad 121 via a conductor formed in an eighth through-hole 111c provided in the protection layer 111. The second lead portion 106b and the third lead portion 108b have the same electric potential.

The first solid electrolyte 105 and the second solid electrolyte 109 are each formed from a partially stabilized zirconia sintered body obtained by adding yttria (Y₂O₃) or calcia (CaO) as a stabilizer to zirconia (ZrO₂).

The heating element 102, the first electrode 104, the second electrode 106, the third electrode 108, the fourth electrode 110, the heater-side pads 120, and the detection-element-side pads 121 can be formed from elements of the platinum group. Examples of suitable elements of the platinum group for forming these include Pt, Rh, Pd, and the like. These elements of the platinum group may be used alone or in a combination of two types or more.

Preferably, the above heating element 102 and the like are mainly formed from Pt from the viewpoints of heat resistance and oxidation resistance. In addition, preferably, the above heating element 102 and the like contain a ceramic component other than the element of the platinum group serving as a main component. From the viewpoint of fixation, this ceramic component is preferably a component that is similar to the material serving as a main component on the side on which these members are stacked.

The insulation layer 107 is formed between the oxygen pump cell 140 and the oxygen concentration detection cell 130 described above. The insulation layer 107 is composed of an insulating portion 114 and a diffusion resistance portion 115. In the insulating portion 114 of the insulation layer 107, a hollow measurement chamber 107c is formed at a position corresponding to the second electrode portion 106a and the third electrode portion 108a. The measurement chamber 107c is in communication with outside the sensor element in the width direction of the insulation layer 107. In each of the communicating portions, the diffusion resistance portion 115 which realizes gas diffusion between the outside and the measurement chamber 107c under a predetermined rate controlling condition is disposed.

The insulating portion 114 is not limited as long as the insulating portion 114 is a ceramic sintered body having insulating property, and is formed from an oxide-based ceramic or the like such as alumina or mullite, for example.

The diffusion resistance portion 115 is a porous body formed from alumina, and the speed of a detection gas flowing into the measurement chamber 107c is adjusted by the diffusion resistance portion 115 formed as a porous body.

At a surface of the second solid electrolyte 109, the protection layer 111 is formed so as to sandwich the fourth electrode 110 therebetween. The protection layer 111 is composed of: a porous electrode protection portion 113a, extending through the protection layer 111, for preventing the fourth electrode portion 110a from being poisoned, in such a manner that the fourth electrode portion 110a is sandwiched; and a reinforcing portion 112 for protecting the second solid electrolyte 109 in such a manner that the fourth lead portion 110b is sandwiched.

The sensor element 100 of the present embodiment is an oxygen sensor element in which: the direction and magnitude of the current flowing between the electrodes of the oxygen pump cell 140 are adjusted such that the voltage (electromotive force) generated between the electrodes of the oxygen concentration detection cell 130 has a predetermined value (e.g., 450 mV); and the oxygen concentration in the measurement target gas corresponding to the current flowing in the oxygen pump cell 140 is linearly detected.

When a cross section of the sensor element 100 perpendicular to the direction of the axial line L is viewed, the cross section has a rectangular shape of which the long sides are the outer edges formed by the protection layer 111 and the first base body 101 and of which the short sides are two sides along the stacking direction of the protection layer 111 and the first base body 101.

With reference back to FIG. 1, the metal shell 30 is made of SUS430, and includes: an external thread portion 31 for attaching the gas sensor 1 to, for example, an exhaust pipe; and a hexagonal portion 32 at which an attachment tool is put at the time of the attachment. In addition, the metal shell 30 is provided with a metal-shell-side step portion 33 protruding toward the radially inner side. The metal-shell-side step portion 33 supports a metal holder 34 for holding the sensor element 100. On the inner side of the metal holder 34, a ceramic holder 35 and a talc 36 are disposed in this order from the front end side.

The talc 36 is composed of a first talc 37 disposed in the metal holder 34, and a second talc 38 disposed at the rear end of the metal holder 34. The first talc 37 is filled and compressed in the metal holder 34, whereby the sensor element 100 is fixed with respect to the metal holder 34. In addition, the second talc 38 is filled and compressed in the metal shell 30, whereby sealability between the outer surface of the sensor element 100 and the inner surface of the metal shell 30 is ensured.

A sleeve 39 made of alumina is disposed on the rear end side of the second talc 38. The sleeve 39 is formed in a multi-stepped cylindrical shape, and an axial hole 39a is provided so as to extend along the axial line L. The sensor element 100 is inserted into the sleeve 39 including the axial hole 39a. A crimping portion 30a on the rear end side of the metal shell 30 is bent inwardly, and the sleeve 39 is pressed by the crimping portion 30a toward the front end side of the metal shell 30 via a stainless steel ring member 40.

A protector 24 made of metal is attached by welding to the outer periphery on the front end side of the metal shell 30. The protector 24 has a double structure. On the outer side of the protector 24, an outer protector 41 in a bottomed cylindrical shape having a uniform outer diameter is disposed. On the inner side of the protector 24, an inner protector 42 in a bottomed cylindrical shape formed is disposed such that the outer diameter of a rear end portion 42a of the inner protector 42 is larger than the outer diameter of a front end portion 42b thereof. The protector 24 covers a front end portion of the sensor element 100, which protrudes from the front end of the metal shell 30, and the protector 24 has a plurality of gas taking-in holes 24a.

The rear end side of the metal shell 30 is inserted in the front end side of an outer casing 25 made of SUS430. The outer casing 25 includes a front end portion 25a of which the front end side has an enlarged diameter. The front end portion 25a is fixed to the metal shell 30 by laser welding or the like. A separator 50 is disposed in the inside on the rear end side of the outer casing 25. A holding member 51 is interposed in a gap formed between the separator 50 and the outer casing 25. The holding member 51 is engaged with a protruding portion 50a protruding outward from the peripheral surface of the separator 50, and is fixed between the separator 50 and the outer casing 25 by having been crimped.

The separator 50 is provided with insertion holes 50b for inserting various types of lead wires 11, 12, 13 for the detection element portion 300 and for the heater portion 200 such that the insertion holes 50b penetrate the separator 50 from the front end side to the rear end side. In FIG. 1, for convenience of description, only three lead wires 11, 12, 13 are shown, and the other lead wires are not shown. Connection terminals 16 which connect the above lead wire 11, etc., and the detection-element-side pads 121 of the detection element portion 300 and the heater-side pads 120 of the heater portion 200 are accommodated in the insertion hole 50b. Each lead wire 11, etc., is configured to be connectable, at the outside of the gas sensor, to a connector (not shown), and input/output of an electric signal is performed between an external device such as an ECU and each lead wire 11, etc., via the connector.

Further, a rubber cap 52 having a substantially circular column shape and for closing an opening 25b on the rear end side of the outer casing 25 is disposed on the rear end side of the separator 50. The rubber cap 52 is fixed to the outer casing 25 by the outer casing 25 being crimped toward the radially inner side in a state where the rubber cap 52 is accommodated in the rear end of the outer casing 25. The rubber cap 52 is also provided with insertion holes 52a for respectively inserting the lead wire 11 and the like such that the insertion holes 52a penetrate the rubber cap 52 from the front end side to the rear end side.

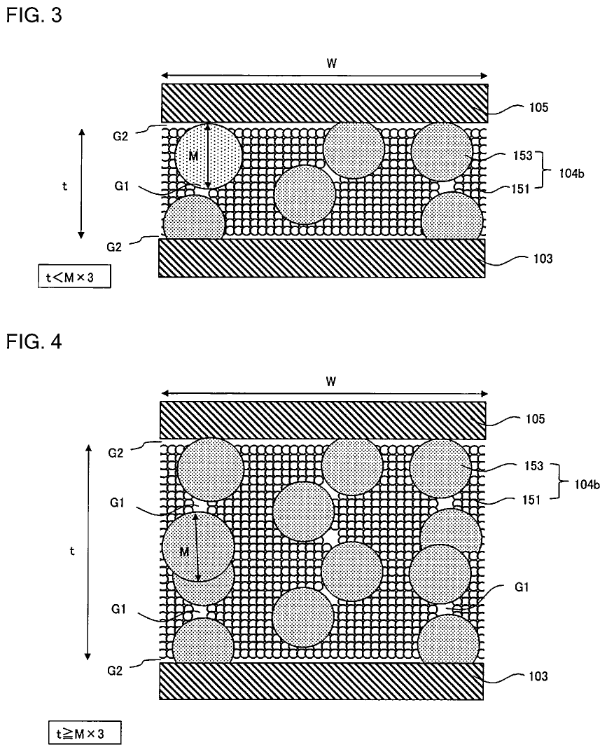

Next, the first lead portion 104b, which is a characteristic part of the present invention, will be described. FIG. 3 is a schematic diagram of a cross section that crosses, in the longitudinal direction of, the first lead portion 104a when t<M×3.

As shown in FIG. 3, the first lead portion 104b is configured to include: noble metal particles 151 of one type or more selected from the group of Pt, Pd, Rh, and Au; ceramic particles 153 having an equivalent circle diameter larger than that of the noble metal particles; and voids G1, G2. The first lead portion 104b is formed of a gas permeable porous body.

The first lead portion 104b faces communication holes (the first through-hole 105a, the second through-hole 107a, the fourth through-hole 109a, and the sixth through-hole 111a) provided in the sensor element 100, and is in communication with outside of the gas sensor 100. The detection-element-side pad 121 that is electrically connected to the sixth through-hole 111a is also formed of a gas permeable porous body.

Reference air on the outside of the gas sensor 100 is supplied to the first electrode portion 104a serving as the reference electrode, via the detection-element-side pad 121, the communication holes, and the first lead portion 104b.

As for the particle sizes of the noble metal particles 151 and the ceramic particles 153, composition analysis of the noble metal particles 151 and the ceramic particles 153 is performed on a cross-sectional view (e.g., an SEM image, see FIG. 3) that crosses, in the longitudinal direction of, the first lead portion 104a, whereby an equivalent circle diameter of an image that corresponds to the contrast of each particle is obtained.

As shown in FIG. 3, a relationship of a lead portion film thickness t<(a maximum particle size M of the ceramic particles 153×3)<a lead portion width W is satisfied.

The voids in the first lead portion 104b include: internal voids G1; and interface voids G2 between the first lead portion 104b and other members (the second base body 103 and the first solid electrolyte 105) that are respectively in contact with both (opposing) surfaces of the first lead portion 104b. The area of the interface voids G2, out of those voids, does not vary to a large extent even when the film thickness t is changed (this is illustrated by comparing, for example, the interface voids G2 in FIG. 3 with those in FIG. 4).

Therefore, when t<M×3 is satisfied, the film thickness t is small, and thus, the number of the internal voids G1 is small (in fact, when t is small, there may be a case where the number of G1 is zero), and thus the interface voids G2 would account for the majority of the voids G1, G2. Therefore, even when the film thickness t is changed, the total area of the voids G1, G2 does not vary to a large extent when t<M×3 is satisfied. Therefore, it is possible to suppress characteristics of the gas sensor from varying due to variation in the detection value (electromotive force) of the gas sensor.

In contrast to this, as shown in FIG. 4, when t≥M×3 is satisfied, the film thickness t is large, and thus, the internal voids G1 increase in number in accordance with increase in the film thickness t, and the total area of the voids G1, G2 increases in accordance with the film thickness t. Therefore, when t≥M×3 is satisfied, the detection value (electromotive force) of the gas sensor varies in accordance with the film thickness t, and characteristics of the gas sensor also vary.

The reason for specifying M×3<W is as follows. When W is too small as compared with t, the proportion of the interface voids G2 in the voids G1, G2 decreases to a large extent. Thus, even when t<M×3 is satisfied, the total area of the voids G1, G2 also varies in association with variation in the film thickness t.

In addition, if the area of G1 accounts for not higher than 10% with respect to the total area of G1 and G2, even when the film thickness t is changed, variation in the total area of the voids G1, G2 is further reduced, and characteristics of the gas sensor can be further suppressed from varying.

A measurement method for the film thickness t of the first lead portion 104b is performed based on a cross-sectional SEM image including the first lead portion 104b as shown in FIG. 6. FIG. 6 is a cross-sectional SEM image of the Example described later.

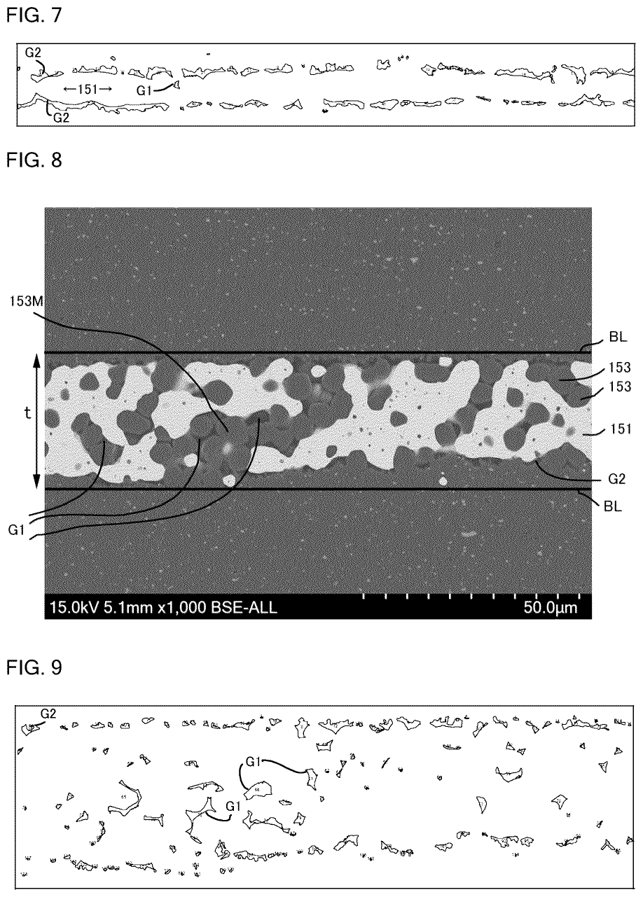

First, the cross-sectional SEM image is subjected to image analysis to be binarized, and portions having a predetermined darkness are regarded as void portions, to extract the voids G1, G2 (e.g., binarization software: ImageJ). FIG. 7 shows the extraction result.

The voids G1, G2 are the darkest part in the cross-sectional SEM image, and the noble metal particles 151 forming the first lead portion 104b are the lightest part. The ceramic particles 153 forming the first lead portion 104a have an intermediate lightness.

The film thickness t is defined as the average value of the widths at three places in the first lead portion 104b.

The voids G2 are interface voids between the first lead portion 104b and the other members (here, the second base body 103 and the first solid electrolyte 105) that are respectively in contact with both surfaces (both ends in the thickness direction) of the first lead portion 104a. Therefore, out of the extracted voids G1, G2, voids that are in contact with the outer sides of the first lead portion 104b are counted as the voids G2, and the other voids are counted as the voids G1 (FIG. 7). Individual voids are counted based on an Analyze Particle command of the above binarization software, and the area of each individual void is further calculated.

Accordingly, the total area of G1 and the total area of G2 can be calculated.

Next, from an end portion of a void G2, out of the voids G2, that connects to the noble metal particles 151 and that is on the outermost side (the up-down direction in FIG. 6) in the thickness direction of the first lead portion 104b, a parallel line BL is drawn in the plane direction (the left-right direction in FIG. 6) of the first lead portion 104a. The parallel line BL is drawn on each of the upper side and the lower side of the first lead portion 104b.

Then, the region of the cross-sectional SEM image between the two parallel lines BL is regarded as the first lead portion 104b, and the interval in the thickness direction of the two parallel lines BL is calculated as the film thickness t.

Out of the voids, those that do not connect to the noble metal particles 151 (i.e., within the field of view of the cross-sectional SEM image, outside the region between the two parallel lines BL) can be considered to be cavities inside the other layers adjacent to the first lead portion 104b, and thus, are excluded.

In a case where, relative to the voids G2 that connect to the noble metal particles 151, another noble metal particle 151 is positioned on the outermost side in the thickness direction, the position of this noble metal particle 151 is used as the position of the parallel line BL.

A measurement method for the maximum particle size M of the ceramic particles 153 is as follows. In the region of the first lead portion 104b between the two parallel lines BL in the above cross-sectional SEM image, the maximum value of the equivalent circle diameter of closed portions of which the outer edges are able to be discerned, out of portions having the lightness regarded as the ceramic particles 153, is used as the maximum particle size M. For example, in the cross section in FIG. 6, the equivalent circle diameter of a ceramic particle 153M, out of several ceramic particles 153 of which the outer edges were able to be discerned, was used as the maximum particle size M.

The present invention is not limited to the above embodiment. It is sufficient that the sensor element has one pair of electrodes and one pair of leads, and the sensor element is applicable to the oxygen sensor (oxygen sensor element) of the present embodiment. It is needless to say that, not limited to these applications, the present invention is applicable to various modifications and equivalents encompassed in the idea and the scope of the present invention.

For example, the present invention may be applied to a full-range oxygen sensor having an oxygen pump cell, an NOx sensor (NOx sensor element) that detects the NOx concentration in a measurement target gas, an HC sensor (HC sensor element) that detects the HC concentration, or the like. In addition, the sensor element may be of a tube type, and may be a binary sensor or a linear sensor.

### EXAMPLE

### Evaluation of Characteristic (Electromotive Force) of Gas Sensor

A sensor element (oxygen sensor element) 100 having a plate shape shown in FIG. 1 and FIG. 2 was produced. As the first lead portion 104b, a paste including noble metal particles made of Pt and alumina particles 153 having an equivalent circle diameter larger than that of the noble metal particles was screen-printed on a predetermined position of the sensor element, and then, the entirety of the resultant matter was sintered and formed. A plurality of sensor elements were made as samples with the printing thickness changed.

Next, the above sensor element 100 was assembled to the gas sensor 1, the gas sensor was heated to a measurement temperature, and a characteristic (electromotive force) of the gas sensor was evaluated in a measurement target atmosphere. Smaller variation in the electromotive force irrespective of variation in the thickness of the first lead portion 104a is favorable.

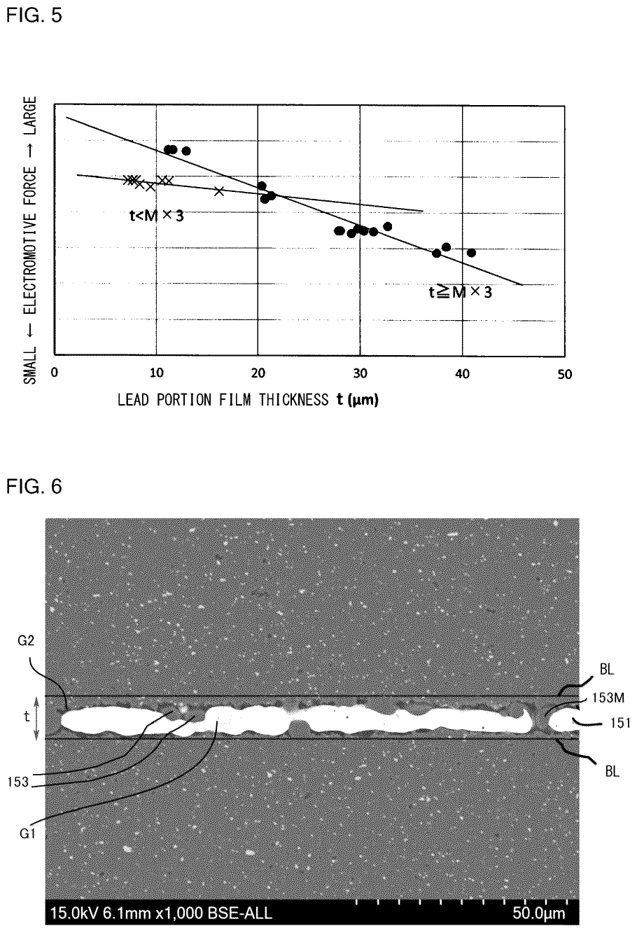

FIG. 5 shows the obtained result.

FIG. 5 shows a relationship between the lead portion film thickness t and the characteristic (electromotive force) of the gas sensor.

As shown in FIG. 5, it was found that, when t<M×3 was satisfied, the change in the detection value (electromotive force) of the gas sensor was small relative to the change in the lead portion film thickness t. Meanwhile, when t≥M×3 was satisfied, the change in the detection value (electromotive force) of the gas sensor became large relative to the change in the lead portion film thickness t.

FIG. 6 and FIG. 8 show cross-sectional SEM images of the first lead portion 104b when t<M×3 and t≥M×3 are satisfied, respectively. FIG. 7 and FIG. 9 show voids G1, G2 extracted through image analysis of FIG. 6 and FIG. 8, respectively.

From the cross-sectional image shown in FIG. 6, the area of G1 relative to the total area of G1 and G2 was calculated through image analysis, and the area of G1 accounted for 0.6%. In another cross-sectional image (not shown) when t<M×3 was satisfied, the area of G1 accounted for 9.3%.

Meanwhile, from the cross-sectional image shown in FIG. 8, the area of G1 relative to the total area of G1 and G2 was calculated through image analysis, and the area of G1 accounted for 42.7%. In another cross-sectional image (not shown) when t≥M×3 was satisfied, the area of G1 accounted for 22.8%.

From this, it is understood that the area of G1 relative to the total area of G1 and G2 is preferably not higher than 10%.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2023-002952 filed Jan. 12, 2023, the disclosure of which is incorporated herein by reference in its entirety.

What is claimed is:

1. A sensor element comprising:
a detection electrode configured to come into contact with a measurement target gas, and a reference electrode configured to come into contact with a reference gas; and
one pair of lead portions respectively connected to the detection electrode and the reference electrode,
the sensor element being configured to measure a target component in the measurement target gas by the detection electrode and the reference electrode, wherein
out of the one pair of lead portions, a reference lead portion that is connected to the reference electrode is configured to include noble metal particles of one type or more selected from the group of Pt, Pd, Rh, and Au, ceramic particles having an equivalent circle diameter larger than that of the noble metal particles, and a void, and
when a cross section that crosses, in a longitudinal direction of, the reference lead portion is viewed, a relationship of a lead portion film thickness t<(a maximum particle size M of the ceramic particles×3)<a lead portion width W is satisfied.

2. The sensor element according to claim 1, wherein
in the cross section, the void includes an internal void G1 in the reference lead portion and an interface void G2 between the reference lead portion and each of other members that are respectively in contact with both surfaces of the reference lead portion, and
an area of G1 accounts for not higher than 10% relative to a total area of G1 and G2.

3. A gas sensor comprising:
the sensor element according to claim 1; and
a metal shell holding the sensor element.

4. A gas sensor comprising:
the sensor element according to claim 2; and
a metal shell holding the sensor element.
